(19) United States
(12) Patent Application Publication
(10) Pub. No.: US 2026/0095889 A1
(43) Pub. Date: Apr. 2, 2026

(54) INDOOR POSITIONING USING AMBIENT-POWER TAGS

(71) Applicant: Samsung Electronics Co., Ltd., Suwon-si (KR)

(72) Inventors: Vishnu Vardhan Ratnam, Frisco, TX (US); Abhishek Sehgal, Frisco, TX (US); Bilal Sadiq, Plano, TX (US); Boon Loong Ng, Plano, TX (US); Rebal Al Jurdi, Allen, TX (US)

(21) Appl. No.: 19/337,837

(22) Filed: Sep. 23, 2025

Related U.S. Application Data
(60) Provisional application No. 63/702,462, filed on Oct. 2, 2024.
(60) Provisional application No. 63/711,581, filed on Oct. 24, 2024.

(51) Int. Cl. H04W 64/00; H04W 4/02; H04W 4/021

(52) U.S. Cl. CPC H04W 64/006; H04W 4/023; H04W 4/021

(57) ABSTRACT

Methods and systems for indoor positioning using battery-less radio frequency tags. A method includes receiving data from ambient-power tags, where the ambient-power tags are configured to function as anchor nodes. The method includes generating zone-level device positioning information based on the data received from the ambient-power tags. The method also includes determining a zone estimation based on one or more metrics collected from the data received from the ambient-power tags. The method further includes receiving sensor data from an inertial measurement unit (IMU)-sensor and adjusting the zone estimation using the sensor data to improve the zone-level device positioning information.

### CROSS-REFERENCE TO RELATED APPLICATIONS AND CLAIM OF PRIORITY

The present application claims priority to U.S. Provisional Patent Application No. 63/702,462, filed on Oct. 2, 2024 and to U.S. Provisional Patent Application No. 63/711,581, filed on Oct. 24, 2024. The contents of the above-identified patent documents are incorporated herein by reference.

### TECHNICAL FIELD

The present disclosure relates generally to wireless communication systems. more specifically, the present disclosure relates to a system and method for indoor positioning using ambient-power tags.

### BACKGROUND

Indoor positioning systems (IPSs), which entail estimating the location of a user within an indoor environment, are used in situations involving smart home applications, industrial automation, asset tracking, and user context prediction. One commonly used IPS technology involves device-based positioning, where the location of a user is estimated by measurements from by a device they carry. To do so, position may be estimated from range measurements with known position coordinates, estimated by accumulating increment displacements on top of a known initial position; the displacements are computed from sensor readings, and predicted from sensor readings. Additionally, indoor positioning systems may use zone detection, where the whole indoor area can be divided into different zones. Rather than estimating the location of the user, these systems estimate the zone in which the user is present.

### SUMMARY

The present disclosure relates generally to wireless communication systems and, more specifically, the present disclosure relates to a system and method for indoor positioning using ambient-power tags.

In one embodiment, a method is provided. The method includes receiving data from ambient-power tags, where the ambient-power tags are configured to function as anchor nodes. The method includes generating zone-level device positioning information based on the data received from the ambient-power tags. The method also includes determining a zone estimation based on one or more metrics collected from the data received from the ambient-power tags. The method further includes receiving sensor data from an inertial measurement unit (IMU)-sensor and adjusting the zone estimation using the sensor data to improve the zone-level device positioning information.

In another embodiment, an electronic device is provided. The electronic device includes a transceiver, and a processor operably coupled to ambient-power tags. The processor is configured to receive data from the ambient-power tags, where the ambient-power tags are configured to function as anchor nodes. The processor is also configured to cause the electronic device to generate zone-level device positioning information based on the data received from the ambient-power tags. The processor is further configured to cause the electronic device to determine a zone estimation based on one or more metrics collected from the data received from the ambient-power tags. The processor is also configured to cause the electronic device to receive sensor data from an inertial measurement unit (IMU)-sensor and adjust the zone estimation using the sensor data to improve the zone-level device positioning information.

In yet another embodiment, a non-transitory computer-readable medium is provided. The non-transitory computer-readable medium includes program code, that when executed by at least one processor of an electronic device, causes the electronic device to receive data from ambient-power tags, where the ambient-power tags are configured to function as anchor nodes. The non-transitory computer-readable medium also includes program code, that when executed by at least one processor of an electronic device, causes the electronic device to generate zone-level device positioning information based on the data received from the ambient-power tags. The non-transitory computer-readable medium further includes program code, which when executed by at least one processor of an electronic device, causes the electronic device to determine a zone estimation based on one or more metrics collected from the data received from the ambient-power tags. The non-transitory computer-readable medium also includes program code, that when executed by at least one processor of an electronic device, causes the electronic device to receive sensor data from an inertial measurement unit (IMU)-sensor and adjust the zone estimation using the sensor data to improve the zone-level device positioning information.

Other technical features may be readily apparent to one skilled in the art from the following figures, descriptions, and claims.

Before undertaking the DETAILED DESCRIPTION below, it may be advantageous to set forth definitions of certain words and phrases used throughout this patent document. The term “couple” and its derivatives refer to any direct or indirect communication between two or more elements, whether or not those elements are in physical contact with one another. The terms “transmit,” “receive,” and “communicate,” as well as derivatives thereof, encompass both direct and indirect communication. The terms “include” and “comprise,” as well as derivatives thereof, mean inclusion without limitation. The term “or” is inclusive, meaning and/or. The phrase “associated with,” as well as derivatives thereof, means to include, be included within, interconnect with, contain, be contained within, connect to or with, couple to or with, be communicable with, cooperate with, interleave, juxtapose, be proximate to, be bound to or with, have, have a property of, have a relationship to or with, or the like. The term “controller” means any device, system, or part thereof that controls at least one operation. Such a controller may be implemented in hardware or a combination of hardware and software and/or firmware. The functionality associated with any particular controller may be centralized or distributed, whether locally or remotely. The phrase “at least one of,” when used with a list of items, means that different combinations of one or more of the listed items may be used, and only one item in the list may be needed. For example, “at least one of: A, B, and C” includes any of the following combinations: A, B, C, A and B, A and C, B and C, and A and B and C.

Moreover, various functions described below can be implemented or supported by one or more computer programs, each of which is formed from computer readable program code and embodied in a computer readable medium. The terms “application” and “program” refer to one or more computer programs, software components, sets of instructions, procedures, functions, objects, classes, instances, related data, or a portion thereof adapted for implementation in a suitable computer readable program code. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device.

Definitions for other certain words and phrases are provided throughout this patent document. Those of ordinary skill in the art should understand that in many if not most instances, such definitions apply to prior as well as future uses of such defined words and phrases.

### BRIEF DESCRIPTION OF THE DRAWINGS

For a more complete understanding of the present disclosure and its advantages, reference is now made to the following description taken in conjunction with the accompanying drawings, in which like reference numerals represent like parts:

FIG. 1 illustrates an example wireless network according to embodiments of the present disclosure;

FIG. 2A illustrates an example access point according to various embodiments of the present disclosure;

FIG. 2B illustrates an example station according to various embodiments of this disclosure;

FIGS. 3A-3B illustrate an example zone map supporting indoor positioning using ambient-power tags according to embodiments of the present disclosure;

FIG. 4 illustrates an example ambient-power tag supporting indoor positioning according to embodiments of the present disclosure;

FIG. 5 illustrates an example deployment of ambient-power tags supporting indoor positioning according to embodiments of the present disclosure;

FIG. 6 illustrates an example user interface supporting indoor positioning using ambient-power tags according to embodiments of the present disclosure;

FIG. 7 illustrates an example zone estimation system supporting indoor positioning using ambient-power tags according to embodiments of the present disclosure;

FIG. 8 illustrates an example process flow diagram of a zone detection module of the zone estimation system of FIG. 7 supporting indoor positioning using ambient-power tags according to embodiments of the present disclosure;

FIG. 9 illustrates an example process flow diagram of a packet reception module of the zone estimation system of FIG. 7 supporting indoor positioning using ambient-power tags according to embodiments of the present disclosure;

FIG. 10 illustrates an example process flow diagram of a mobility module of the zone estimation system of FIG. 7 supporting indoor positioning using ambient-power tags according to embodiments of the present disclosure; and

FIG. 11 illustrates an example flow chart of a method for indoor positioning using ambient-power tags according to embodiments of the present disclosure.

### DETAILED DESCRIPTION

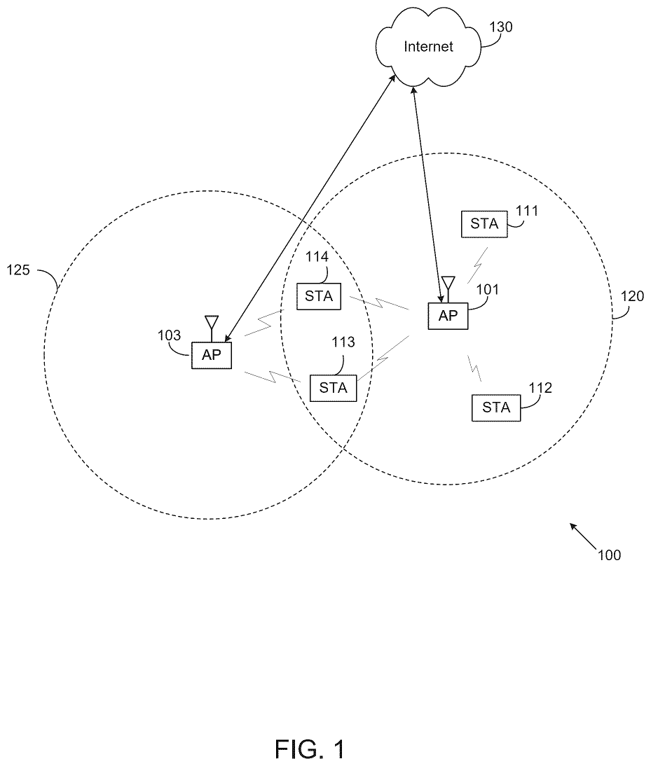

FIG. 1 through FIG. 11, discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably arranged system or device.

As introduced above, indoor positioning systems (IPSs), which entail estimating the location of a user within an indoor environment, are used in situations involving smart home applications, industrial automation, asset tracking, and user context prediction. One commonly used IPS technology involves device-based positioning, where the location of a user is estimated by measurements from by a device they carry. To do so, position may be estimated from range measurements, such as measurements of distance with anchor points, or reference points, with known position coordinates. Range measurements (including differential ranges), include received signal strength indicator (RSSI), time of flight (ToF), round-trip time (RTT), and time difference of arrival (TDoA), which are available in common wireless technologies, such as WiFi, Bluetooth, and ultra-wide band (UWB). Position may also be estimated by accumulating increment displacements on top of a known initial position; the displacements are computed from sensor readings, e.g., magnetometer, accelerometer, and gyroscope. Position may also be predicted from sensor readings through PDR and then updated through fusion with range measurements.

In certain cases, it may be sufficient to predict the approximate location or area in which the user is present, rather than estimating his exact location. This type of indoor positioning system is based on zone detection, where the whole indoor area can be divided into different zones. Rather than estimating the location of the user, these systems estimate the zone in which the user is present.

However, these systems for wireless or RF based positioning may require installation of multiple high-cost anchors that are either battery operated or require a power supply and also require advanced capabilities at both the anchors and the user device, such as compatibility with IEEE 802.11mc or IEEE 802.11az standards. The exact locations of the anchors also need to be pre-configured, increasing the cost of implementation.

Although, inertial motion unit (IMU) sensors are now present on most user devices and they make it practically viable to implement PDR algorithms on user devices such as smart phones, these methods are prone to error accumulation which leads to deviation in their estimated trajectory over time. Furthermore, due to the poor accuracy of the magnetometer in most commercial smart phones, PDR only provides an estimate of the relative trajectory and orientation, and a good initial estimate of the user location and heading direction are still required, making things challenging. There are also challenges regarding the generalization of the PDR solution to different possible user movements, such as jumping and hand sway. As such, positioning systems using only PDR are also impractical. Several solutions have been proposed for fusing the output from RF-based positioning and PDR, via Particle filters, and Kalman filters, but these suffer from the same practical hinderances of RF based positioning as discussed above.

Ambient-power internet-of-things (IoT) devices are a small form-factor, inexpensive battery-less devices which can harvest energy from the environment including solar power, RF power (such as from other nearby wireless transmitters), and heat, and can transmit packets once the harvested energy reaches a critical threshold value. These packet transmissions are often in the 2.4 GHz Wi-Fi or 2.4 GHz Bluetooth protocols. Due to their low cost, battery-less nature, and use of the WiFi and Bluetooth protocols, these ambient-power IoT devices are a viable choice of anchors for RF based positioning.

Due to their small form-factor, low-cost, battery-less nature, and transmission in protocols, ambient-power IoT tags are an ideal candidate for being deployed as anchors for an RF-based indoor positioning system (IPS). However, the battery-less and low-cost nature of these tags makes them unreliable and sporadic transmitters, thus introducing significant latency. Many of these ambient-power tags also transmit at a very low power and along a single polarization, which makes the received signal power susceptible to receiver orientation and channel noise and interference. These make the use of these tags for IPS applications quite challenging.

Accordingly, the present disclosure provides systems and methods for indoor positioning using ambient-power tags. As described herein, the present disclosure includes systems and methods that include generating zone-level device positioning information based on the data received from the ambient-power tags, determining a zone estimation based on one or more metrics collected from the data received from the ambient-power tags, receiving sensor data from an inertial measurement unit (IMU)-sensor, and adjusting the zone estimation using the sensor data to improve the zone-level device positioning information. The present disclosure provides methods for using the unreliable, sporadic, and noisy information from inexpensive ambient-power tags to generate user positioning information. In particular, this disclosure provides for device-based zone-level indoor positioning using ambient-power internet of things (IoT) tags as anchor nodes. The methods and systems of this disclosure also leverage side information, such as from an IMU-sensor, to enhance the performance of the indoor positioning system.

FIG. 1 illustrates an example wireless network 100 according to various embodiments of the present disclosure. The embodiment of the wireless network 100 shown in FIG. 1 is for illustration only. Other embodiments of the wireless network 100 could be used without departing from the scope of the present disclosure.

The wireless network 100 includes access points (APs) 101 and 103. The APs 101 and 103 communicate with at least one network 130, such as the Internet, a proprietary Internet Protocol (IP) network, or other data network. The AP 101 provides wireless access to the network 130 for a plurality of stations (STAs) 111, 112, 113, and 114 within a coverage area 120 of the AP 101. The APs 101-103 may communicate with each other and with the STAs 111-114 using Wi-Fi, Ultra-Wide Band (UWB), or other WLAN communication techniques.

Depending on the network type, other well-known terms may be used instead of “access point” or “AP,” such as “router” or “gateway.” For the sake of convenience, the term “AP” is used in this disclosure to refer to network infrastructure components that provide wireless access to remote terminals. In WLAN, given that the AP also contends for the wireless channel, the AP may also be referred to as a STA. Also, depending on the network type, other well-known terms may be used instead of “station” or “STA,” such as “mobile station,” “subscriber station,” “remote terminal,” “user equipment,” “wireless terminal,” or “user device.” For the sake of convenience, the terms “station” and “STA” are used in this disclosure to refer to remote wireless equipment that wirelessly accesses an AP or contends for a wireless channel in a WLAN, whether the STA is a mobile device (such as a mobile telephone or smartphone) or is normally considered a stationary device (such as a desktop computer, AP, media player, stationary sensor, television, etc.).

Dotted lines show the approximate extents of the coverage areas 120 and 125, which are shown as approximately circular for the purposes of illustration and explanation only. It should be clearly understood that the coverage areas associated with APs, such as the coverage areas 120 and 125, may have other shapes, including irregular shapes, depending upon the configuration of the APs and variations in the radio environment associated with natural and man-made obstructions.

As described in more detail below, one or more of the APs may include circuitry and/or programming for estimating a user velocity based on multi-antenna WiFi signals in WLANs. Although FIG. 1 illustrates one example of a wireless network 100, various changes may be made to FIG. 1. For example, the wireless network 100 could include any number of APs and any number of STAs in any suitable arrangement. Also, the AP 101 could communicate directly with any number of STAs and provide those STAs with wireless broadband access to the network 130. Similarly, each AP 101-103 could communicate directly with the network 130 and provide STAs with direct wireless broadband access to the network 130. Further, the APs 101 and/or 103 could provide access to other or additional external networks, such as external telephone networks or other types of data networks.

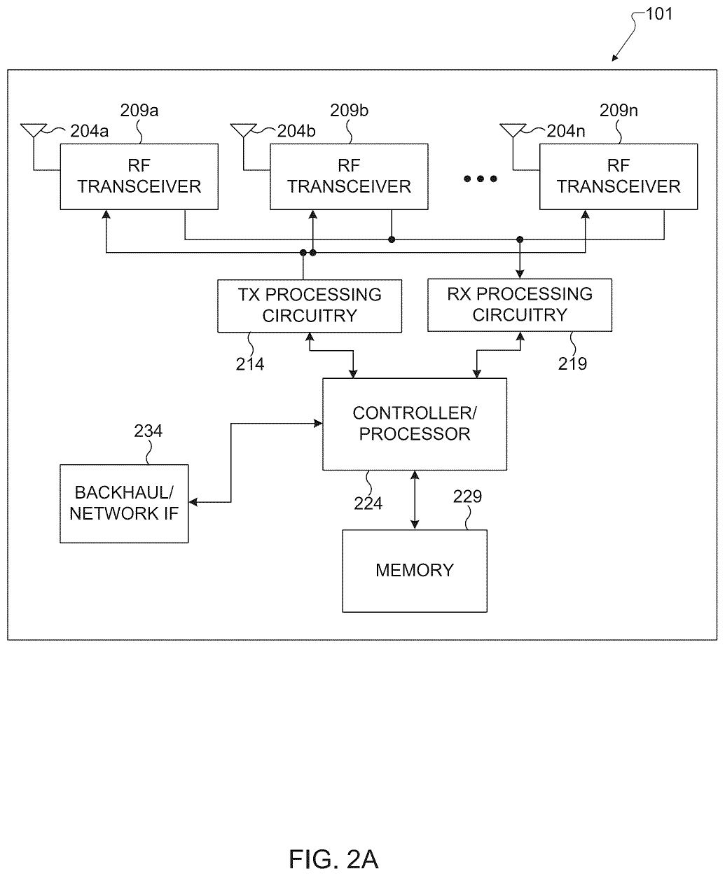

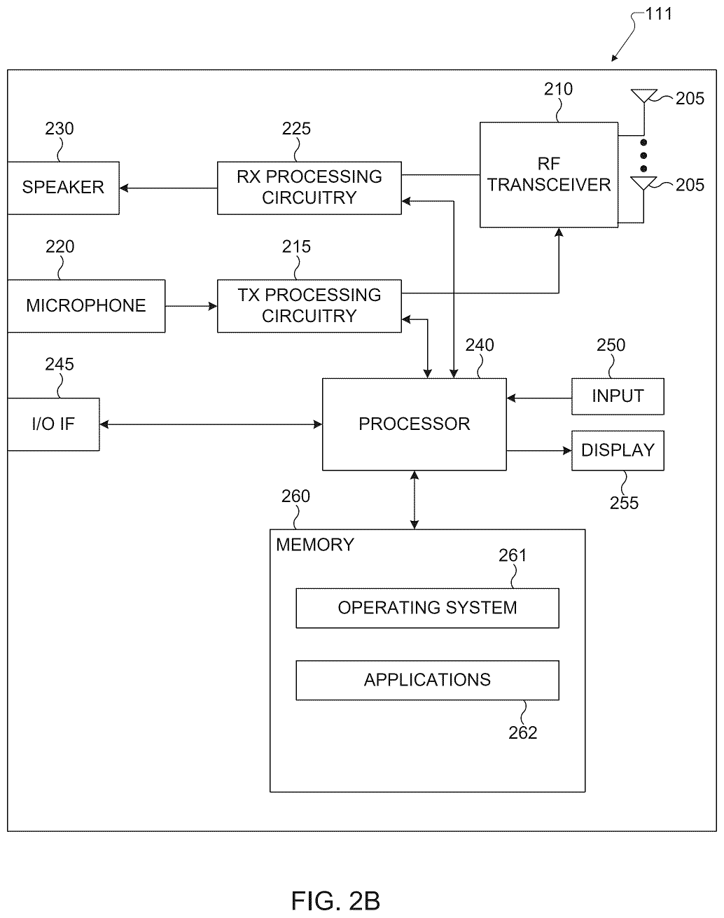

FIG. 2A illustrates an example AP 101 according to various embodiments of the present disclosure. The embodiment of the AP 101 illustrated in FIG. 2A is for illustration only, and the AP 103 of FIG. 1 could have the same or similar configuration. However, APs come in a wide variety of configurations, and FIG. 2A does not limit the scope of the present disclosure to any particular implementation of an AP.

The AP 101 includes multiple antennas 204a-204n, multiple RF transceivers 209a-209n, transmitter processing circuitry 214, and receiver processing circuitry 219. The AP 101 also includes a controller/processor 224, a memory 229, and a backhaul or network interface 234. The RF transceivers 209a-209n receive, from the antennas 204a-204n, incoming RF signals, such as signals transmitted by STAs in the network 100. The RF transceivers 209a-209n down-convert the incoming RF signals to generate IF or baseband signals. The IF or baseband signals are sent to the receiver processing circuitry 219, which generates processed baseband signals by filtering, decoding, and/or digitizing the baseband or IF signals. The receiver processing circuitry 219 transmits the processed baseband signals to the controller/processor 224 for further processing.

The transmitter processing circuitry 214 receives analog or digital data (such as voice data, web data, e-mail, or interactive video game data) from the controller/processor 224. The transmitter processing circuitry 214 encodes, multiplexes, and/or digitizes the outgoing baseband data to generate processed baseband or IF signals. The RF transceivers 209a-209n receive the outgoing processed baseband or IF signals from the transmitter processing circuitry 214 and up-converts the baseband or IF signals to RF signals that are transmitted via the antennas 204a-204n.

The controller/processor 224 can include one or more processors or other processing devices that control the overall operation of the AP 101. For example, the controller/processor 224 could control the reception of forward channel signals and the transmission of reverse channel signals by the RF transceivers 209a-209n, the receiver processing circuitry 219, and the transmitter processing circuitry 214 in accordance with well-known principles. The controller/processor 224 could support additional functions as well, such as more advanced wireless communication functions. For instance, the controller/processor 224 could support beam forming or directional routing operations in which outgoing signals from multiple antennas 204a-204n are weighted differently to effectively steer the outgoing signals in a desired direction. The controller/processor 224 could also support OFDMA operations in which outgoing signals are assigned to different subsets of subcarriers for different recipients (e.g., different STAs 111-114). Any of a wide variety of other functions could be supported in the AP 101 by the controller/processor 224 including estimating a user velocity based on multi-antenna WiFi signals. In some embodiments, the controller/processor 224 includes at least one microprocessor or microcontroller. The controller/processor 224 is also capable of executing programs and other processes resident in the memory 229, such as an OS. The controller/processor 224 can move data into or out of the memory 229 as required by an executing process.

The controller/processor 224 is also coupled to the backhaul or network interface 234. The backhaul or network interface 234 allows the AP 101 to communicate with other devices or systems over a backhaul connection or over a network. The interface 234 could support communications over any suitable wired or wireless connection(s). For example, the interface 234 could allow the AP 101 to communicate over a wired or wireless local area network or over a wired or wireless connection to a larger network (such as the Internet). The interface 234 includes any suitable structure supporting communications over a wired or wireless connection, such as an Ethernet or RF transceiver. The memory 229 is coupled to the controller/processor 224. Part of the memory 229 could include a RAM, and another part of the memory 229 could include a Flash memory or other ROM.

As described in more detail below, the AP 101 may include circuitry and/or programming for estimating a user velocity based on multi-antenna WiFi signals. Although FIG. 2A illustrates one example of AP 101, various changes may be made to FIG. 2A. For example, the AP 101 could include any number of each component shown in FIG. 2A. As a particular example, an access point could include a number of interfaces 234, and the controller/processor 224 could support routing functions to route data between different network addresses. As another particular example, while shown as including a single instance of transmitter processing circuitry 214 and a single instance of receiver processing circuitry 219, the AP 101 could include multiple instances of each (such as one per RF transceiver). Alternatively, only one antenna and RF transceiver path may be included, such as in other APs. Also, various components in FIG. 2A could be combined, further subdivided, or omitted and additional components could be added according to particular needs.

FIG. 2B illustrates an example STA 111 according to various embodiments of this disclosure. The embodiment of the STA 111 illustrated in FIG. 2B is for illustration only, and the STAs 111-115 of FIG. 1 could have the same or similar configuration. However, STAs come in a wide variety of configurations, and FIG. 2B does not limit the scope of the present disclosure to any particular implementation of a STA.

The STA 111 includes antenna(s) 205, a radio frequency (RF) transceiver 210, transmitter processing circuitry 215, a microphone 220, and receiver processing circuitry 225. The STA 111 also includes a speaker 230, a controller/processor 240, an input/output (I/O) interface (IF) 245, a touchscreen 250, a display 255, and a memory 260. The memory 260 includes an operating system (OS) 261 and one or more applications 262.

The RF transceiver 210 receives, from the antenna(s) 205, an incoming RF signal transmitted by an AP of the network 100. The RF transceiver 210 down-converts the incoming RF signal to generate an intermediate frequency (IF) or baseband signal. The IF or baseband signal is sent to the receiver processing circuitry 225, which generates a processed baseband signal by filtering, decoding, and/or digitizing the baseband or IF signal. The receiver processing circuitry 225 transmits the processed baseband signal to the speaker 230 (such as for voice data) or to the controller/processor 240 for further processing (such as for web browsing data).

The transmitter processing circuitry 215 receives analog or digital voice data from the microphone 220 or other outgoing baseband data (such as web data, e-mail, or interactive video game data) from the controller/processor 240. The transmitter processing circuitry 215 encodes, multiplexes, and/or digitizes the outgoing baseband data to generate a processed baseband or IF signal. The RF transceiver 210 receives the outgoing processed baseband or IF signal from the transmitter processing circuitry 215 and up-converts the baseband or IF signal to an RF signal that is transmitted via the antenna(s) 205.

The controller/processor 240 can include one or more processors and execute the basic OS program 261 stored in the memory 260 in order to control the overall operation of the STA 111. In one such operation, the main controller/processor 240 controls the reception of forward channel signals and the transmission of reverse channel signals by the RF transceiver 210, the receiver processing circuitry 225, and the transmitter processing circuitry 215 in accordance with well-known principles. In some embodiments, the controller/processor 240 includes at least one microprocessor or microcontroller.

The controller/processor 240 is also capable of executing other processes and programs resident in the memory 260, such as operations for determining a position of a tag based on anchor signals. The controller/processor 240 can move data into or out of the memory 260 as required by an executing process. In some embodiments, the controller/processor 240 is configured to execute a plurality of applications 262. The controller/processor 240 can operate the plurality of applications 262 based on the OS program 261 or in response to a signal received from an AP. The main controller/processor 240 is also coupled to the I/O interface 245, which provides STA 111 with the ability to connect to other devices such as laptop computers and handheld computers. The I/O interface 245 is the communication path between these accessories and the main controller 240.

The controller/processor 240 is also coupled to the touchscreen 250 and the display 255. The operator of the STA 111 can use the touchscreen 250 to enter data into the STA 111. The display 255 may be a liquid crystal display, light emitting diode display, or other display capable of rendering text and/or at least limited graphics, such as from web sites. The memory 260 is coupled to the controller/processor 240. Part of the memory 260 could include a random access memory (RAM), and another part of the memory 260 could include a Flash memory or other read-only memory (ROM).

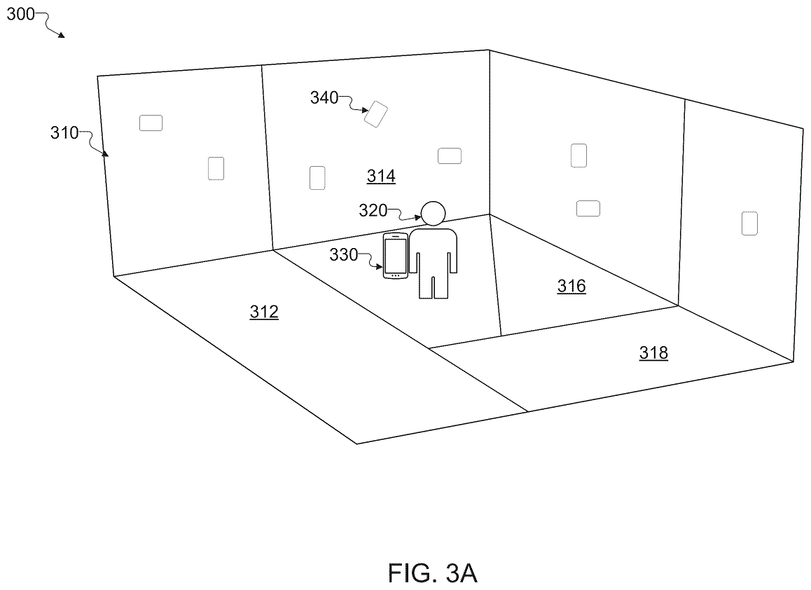

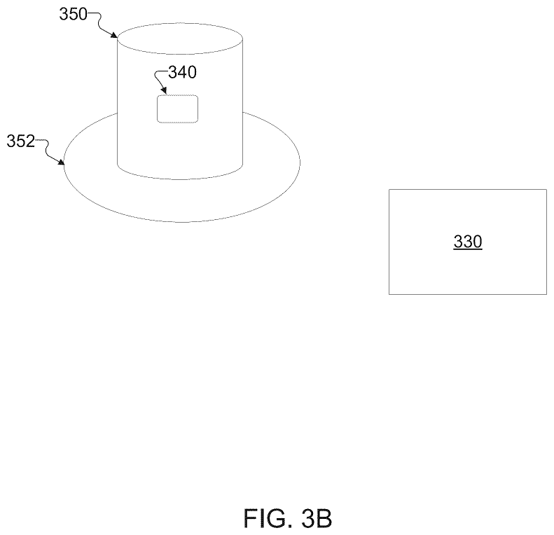

Although FIG. 2B illustrates one example of STA 111, various changes may be made to FIG. 2B. For example, various components in FIG. 2B could be combined, further subdivided, or omitted and additional components could be added according to particular needs. In particular examples, the STA 111 may include any number of antenna(s) 205 for MIMO communication with an AP 101. In another example, the STA 111 may not include voice communication or the controller/processor 240 could be divided into multiple processors, such as one or more central processing units (CPUs) and one or more graphics processing units (GPUs). Also, while FIG. 2B illustrates the STA 111 configured as a mobile telephone or smartphone, STAs could be configured to operate as other types of mobile or stationary devices. The UE 116 may also be configured for indoor positioning using one or more ambient-power tags (such as one or more STAs 111), as shown in FIG. 3.

FIGS. 3A-3B illustrate an example zone map 300 supporting indoor positioning using ambient-power tags according to embodiments of the present disclosure. The embodiment of the zone map 300 shown in FIG. 3 is for illustration only. Other embodiments of the zone map 300 could be used without departing from the scope of this disclosure.

As shown in FIGS. 3A-3B, the zone map 300 includes zones 310, such as a first zone 312, a second zone 314, a third zone 316, and a fourth zone 318. The zones 310 is configured to represent a physical area within an environment that a user 320, carrying or otherwise using a user device 330, is located in. The zone map 300, such as in each of the zones 310, may include ambient-power tags 340 configured for indoor positioning and communicatively or operatively coupled to the user device 330.

The zone map 300 may have Z zones 310 indexed as [symbol] ={1, . . . , Z}. The zone map 300 also has/battery-less tags 340 as anchors, indexed as [symbol] ={1, 2, . . . , I}. There may be a pre-determined mapping function ƒ(·) which maps each anchor index to its assigned zone, that is, ƒ(i)=z if tag i belongs to zone z.

As shown in FIG. 3B, the ambient-power tags 340 may be configured for proximity detection within a zone. For example, a user device 330 (such as a robot) may identify distance from an object 350 using the ambient-power tags 340 and determine whether the distance is within a proximity area 352 (such as when the distance is below a certain threshold). This proximity detection can be used to avoid collision with an object 350.

Although FIGS. 3A-3B illustrate one example of a zone map supporting indoor positioning using ambient-power tags according to embodiments of the present disclosure, various changes may be made to FIGS. 3A-3B. For example, various components of FIGS. 3A-3B could be combined, further subdivided, or omitted and additional components could be added according to particular needs.

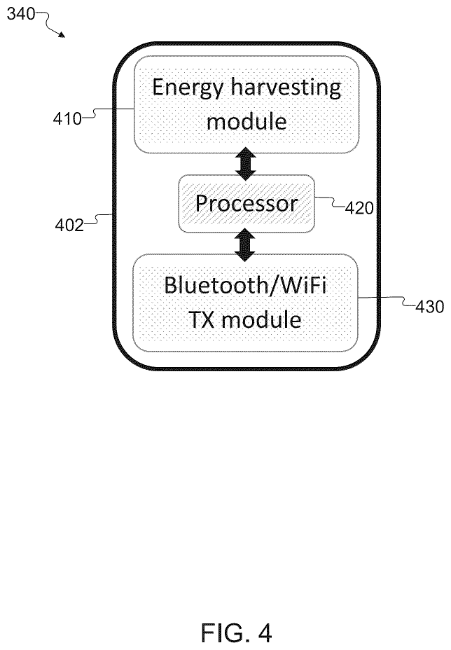

FIG. 4 illustrates an example ambient-power tag 340 supporting indoor positioning according to embodiments of the present disclosure. For ease of explanation, the ambient-power tag 340 will be described as including one or more components of the wireless network 90 of FIG. 1, such as the gNB 92; however, the ambient-power tag 340 could be implemented using any other suitable device or system. The embodiment of the ambient-power tag 340 shown in FIG. 4 is for illustration only. Other embodiments of the ambient-power tag 340 could be used without departing from the scope of this disclosure.

As shown in FIG. 4, the ambient-power tags 340 includes a tag body 402 that houses an energy harvesting module 410, at least one processor 420, and a communication module 430.

The ambient-power tags 340 may absorb ambient energy from the surroundings in specific bands, such as RF energy from Bluetooth or Wi-Fi transmissions in 2.4 GHz, or solar energy, or heat energy, and may transmit wireless packets, such as Bluetooth packets or Wi-Fi packets or cellular-standard (3GPP)-compliant packets, after absorbing a sufficient amount of energy and/or after receiving a trigger to transmit the packets. These packets may further be transmitted on a specific pre-determined wireless channel, such a Bluetooth channel 37. The environment may further have one or more user device 330s, each of whom carries a user device 330, such as a phone. It may be assumed that the user device 330 is capable of receiving the wireless signal emitted by the ambient-power tags 340, such as Bluetooth signals. From each received packet n, the user device 330 may obtain one or more of:
(i) the time stamp of reception of the packet: tn. This time can be measured the local time reference maintained by the user device 330.
(ii) the identifier of the transmitting tag, iₙ∈ [symbol] . These can be identified using, for example the advertisement address or MAC address of the packet, and/or any unique identifier transmitted in the payload of the packet.
(iii) the zone associated with the transmitting tag, zₙ∈ [symbol] . This information can be encoded in the payload of the packet, or the user device 330 may maintain the mapping function ƒ(·) to map the identifier of the transmitting tag to the zone it belongs to.
(iv) the received signal strength of the received packet: Rn. This can be obtained from the received signal strength indication (RSSI) computation from the received packet.

Additionally or alternatively, the user device 330 may also be capable of estimating whether the user device 330 is stationary or in motion, using for example, an IMU sensor. Correspondingly at any time t, the device may be capable of indicating its current state s, as well as the time \tilde{t} since when the current state s is active. For example, the current state may be s=0 if the device is stationary, s=1 if the device is moving at slow speed, s=2 when device is moving at a fast speed, or other suitable speed values.

Note that the above example scenario is provided for ease of exposition and should not be considered as a limitation of the present disclosure. For example, in some embodiments, instead of predicting the zone of a user device 330, the ambient-power tags 340 and the user device 330 may predict the range (distance) of the user device 330 from an ambient-power tags 340 or one of the zones 310 or may predict the location of the user device 330. This may use, for example, a mapping function that associates different packet parameters to distance.

In an alternative embodiment, the ambient-power tags 340 may transmit Wi-Fi packets or cellular standard-compliant packets (such as 3GPP). In the case of Wi-Fi, the ambient-power tags 340 may transmit one or more packets after winning a transmit opportunity (TXOP) or in response to a trigger frame sent from the access point or another Wi-Fi device. In the case of 3GPP transmissions again, the packet transmissions may happen within an uplink grant provided to the tag or zone by a base station. In these cases, the computation of the zone metric M(z,t) may take into consideration that the packet transmissions are not uniformly distributed but are rather transmitted within the TXOPs or uplink grants. For example, the discount function g(·) may be modified to only average the packet parameters received within the most recent TXOP or the uplink grant. As an example, the zone metric M(z, t̅ₙ) at the zone detection time t̅ₙ can be given as either the (i) average RSSI, (ii) number of received packets (iii) or a hybrid metric combining both RSSI values and number of packets, received in the last TXOP with the ambient-power tags 340, or the last uplink grant allocated to the ambient-power tags 340. In other words, the allocated time windows for transmission of packets may also be taken into consideration when determining the zone metrics.

Although FIG. 4 illustrates one example of an ambient-power tag supporting indoor positioning, various changes may be made to FIG. 4. For example, various components of FIG. 4 could be combined, further subdivided, or omitted and additional components could be added according to particular needs.

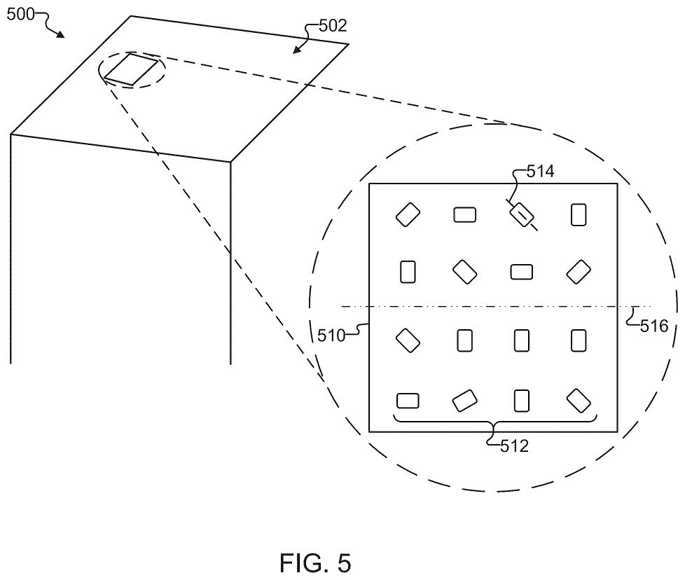

FIG. 5 illustrates an example deployment 500 of ambient-power tags supporting indoor positioning according to embodiments of the present disclosure. The embodiment of the deployment 500 shown in FIG. 5 is for illustration only. Other embodiments of the deployment 500 could be used without departing from the scope of this disclosure.

As shown in FIG. 5, the deployment 500 may include a tag array 510 disposed, for example, on a ceiling or upper portion 502 of a zone. The tag array 510 includes an array of ambient-power tags 340 in a tag arrangement 512 where each of the ambient-power tags 340 includes its own orientations 514. For example, the tag array 510 may be a four-by-four array where each row of the ambient-power tags 340 includes a different orientations 514 (such as a tag at zero degrees, 35 degrees, 80 degrees, and 135 degrees from a center axis 516 of the tag array 510.

In one embodiment, it may be desirable to have a direct line-of-sight (LoS) path between the ambient-power tags 340 and the user device 330 to enable accurate zone estimation. This can be to ensure (i) a low packet error rate, and (ii) also to ensure that the measured packet RSSI Rₙ is representative of the distance to the tag. To maximize the likelihood of an LoS path, the ambient-power tags 340 within each zone may be placed in multiple locations of the zone so that likelihood of LoS from at least a few of the ambient-power tags 340 of the zone is high. Additionally or alternatively, the ambient-power tags 340 within each zone may be deployed on the ceiling, or high up on the side walls to maximize chance of LoS path being present between the tag and the user device 330.

In one embodiment, it may be desirable to receive packets from the ambient-power tags 340 at a faster rate to ensure the latency of zone detection is low. As such, the ambient-power tags 340 may be placed in close proximity to the source of ambient energy, such as RF transmitters, Wi-Fi access points, windows, or a combination thereof. This can be to ensure they can accumulate energy faster and therefore transmit packets at a faster rate. Additionally or alternatively, a large number of tags can be deployed for each zone with the same orientation, so that the aggregated packet rate from each zone is large even if each individual tag transmits at a lower rate.

In one embodiment, the transmissions from the ambient-power tags 340 may be along a single antenna polarization and/or the receive antenna on the user device 330 may also have a single polarization. As such, the user device 330 orientation may impact the packet error rate and the measured RSSI Rₙ. To reduce the impact of the user device 330 orientation on the performance of zone detection, multiple tags 340 may be placed within a zone 310 in different orientations 514 to ensure at least a few tags 340 have polarizations that align with the receiver antenna.

Although FIG. 5 illustrates one example of a deployment of ambient-power tags supporting indoor positioning, various changes may be made to FIG. 5. For example, various components of FIG. 5 could be combined, further subdivided, or omitted and additional components could be added according to particular needs.

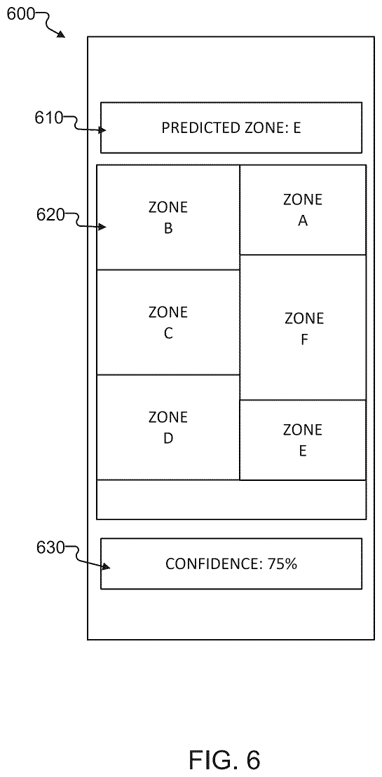

FIG. 6 illustrates an example user interface 600 supporting indoor positioning using ambient-power tags according to embodiments of the present disclosure. The embodiment of the user interface 600 shown in FIG. 6 is for illustration only. Other embodiments of the user interface 600 could be used without departing from the scope of this disclosure.

As shown in FIG. 6, the user interface 600 includes a zone prediction 610, a zone map 620, and a confidence score 630. The user device 330 may have an application or system that is responsible for generating the zone estimation and may include an output to the user device 330 (such as a graphic user interface (GUI)) that has the zone map 620 of the indoor environment identifying the different zones, and the such as the zone prediction 610 may be depicted as text on the GUI or it may be depicted via animation on the zone output. Along with the predicted zone, additional information may also be optionally depicted, such as whether the user device 330 is moving or is stationary, the confidence of the zone prediction (such as by the confidence score 630), or other desired information.

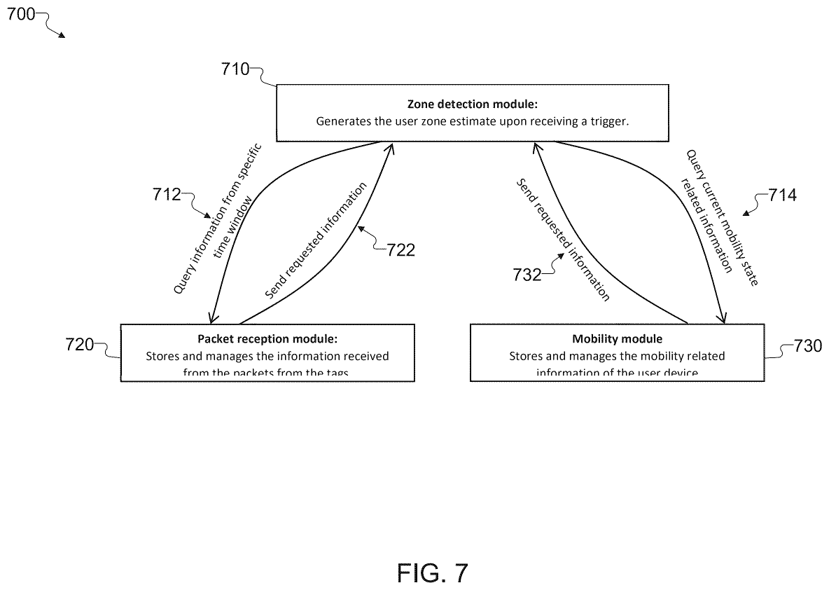

This application can be triggered by either a user device 330 command or an external signal from other processes that use the zone estimates. In addition, the trigger may also indicate the periodicity and or duration for which the zone estimates may be required. The zone estimation system may have several sub-modules responsible for different portions of estimation as shown in FIG. 7.

Although FIG. 6 illustrates one example of a user interface supporting indoor positioning using ambient-power tags, various changes may be made to FIG. 6. For example, various components of FIG. 6 could be combined, further subdivided, or omitted and additional components could be added according to particular needs. Additionally, the user interface may be configured to execute a zone estimation system as shown in FIGS. 7-11.

FIG. 7 illustrates an example zone estimation system 700 supporting indoor positioning using ambient-power tags according to embodiments of the present disclosure. The embodiment of the zone estimation system 700 shown in FIG. 7 is for illustration only. Other embodiments of the zone estimation system 700 could be used without departing from the scope of this disclosure.

As shown in FIG. 7, the zone estimation system 700 includes a zone detection module 710 coupled to a packet reception module 720 and to a mobility module 730. The zone detection module 710, upon initiating zone estimation, is configured to transmit an information query 712 to the packet reception module 720 and a mobility query 714 to the mobility module 730. In response to the information query 712, the packet reception module 720 transmits or otherwise provides packet reception data 722 to the zone detection module 710. Similarly, in response to the mobility query 714, the mobility module 730 transmits or otherwise provides requested mobility data 732 to the zone detection module 710.

The zone detection module 710, upon triggering, will periodically compute a metric for each zone and generate the user device 330 zone estimation based on the computed metrics. The zone detection module 710 may further query other modules, such as the packet reception module 720 and the packet reception module 720 for obtaining information to generate the zone-specific metrics.

The packet reception module 720, which scans for received packets from the ambient-power tags and for each received packet n, stores the values of one or more of: the time of reception of the packet tₙ, an identifier of the transmitting tag iₙ, the zone corresponding to the received packet zₙ and the RSSI from the packet Rₙ. These values can be stored in a buffer which may periodically empty values older than a certain threshold time T̅. Additionally or alternatively, the packet reception module 720 may also generate and maintain some zone-specific metrics.

The mobility module 730 uses the IMU sensor or any other sensor on the receiver to identify the current mobility state s of the user device 330. A person rotating the receiver while standing stationary may be classified as the user device 330 being static. The mobility module 730 may also save the time since the current mobility state of the user device 330 is active. Additionally or alternatively, the mobility module 730 may also indicate the location of the receiver over the past T seconds, where the location is relative to an arbitrary reference point and an arbitrary axis orientation.

Each of these modules may operate in parallel, for example on multiple threads, and may generate new data at different periodicities or upon receiving specific triggers. These data may then be stored in buffers which can be queried and accessed by the other modules. These buffers may maintain the data up to a maximum buffer size B or may store the data corresponding to the past T seconds, where B and T are configurable parameters. Once the threshold is crossed the oldest data in the buffer may be discarded.

Although FIG. 7 illustrates one example of a zone estimation system supporting indoor positioning using ambient-power tags, various changes may be made to FIG. 7. For example, various components of FIG. 7 could be combined, further subdivided, or omitted and additional components could be added according to particular needs.

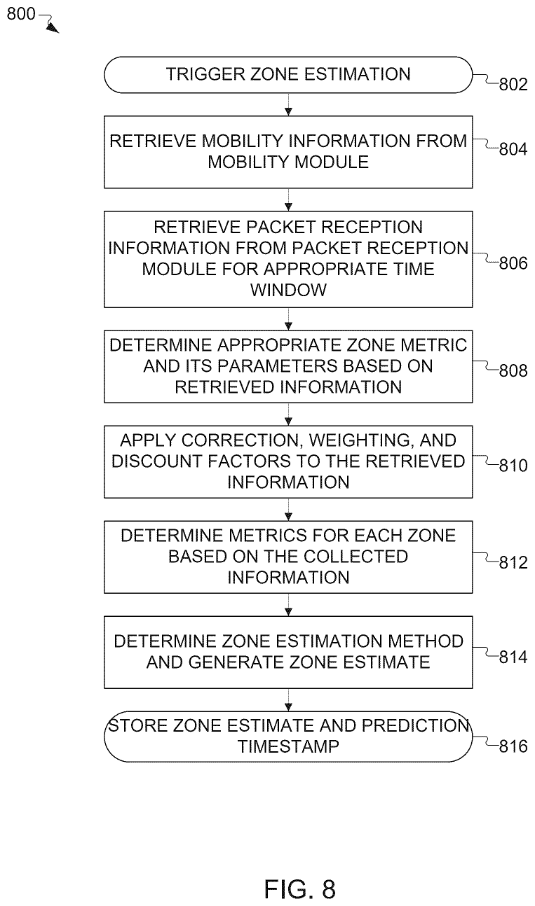

FIG. 8 illustrates an example process flow diagram 800 of a zone detection module of the zone estimation system 700 of FIG. 7 supporting indoor positioning using ambient-power tags according to embodiments of the present disclosure. The embodiment of the process flow diagram 800 shown in FIG. 8 is for illustration only. Other embodiments of the process flow diagram 800 could be used without departing from the scope of this disclosure.

As shown in FIG. 8, the zone detection module 710 may trigger zone estimation at operation 802. For example, zone estimation may be triggered manually by the user 320 or as part of a schedule, such as a periodic zone measurement schedule.

The zone detection module 710 may retrieve mobility information from the mobility module 730 at operation 804. For example, the 710 may transmit a mobility query 714 to the mobility module 730 to request the mobility data 732.

The zone detection module 710 may retrieve packet reception information from the packet reception module 720 at operation 806. For example, the 710 may transmit an information query 712 to the packet reception module 720 to request the packet reception data 722.

The zone detection module 710 may determine an appropriate zone metric and its parameters based on the retrieved information at operation 808. For example, the zone detection module 710 may compute a zone metric M(z,t) for each zone z∈ [symbol] , at specific time instances t∈{t̅₁, t̅₂, . . . } after being triggered to generate the zone prediction by the user device 330 or via other processes. These specific time instances may be either: (i) periodic, where the periodicity is either fixed or is context dependent, or (ii) event driven, such as upon reception of a threshold number of packets from the ambient-power tags 340. For example, a more frequent prediction may be generated when the current mobility state of the user device 330 is moving and a less frequent prediction may be generated when the current mobility state of the user device 330 is static.

To generate the zone metric, the zone detection module 710 at each instant t̅ⱼ may query the mobility module 730 to retrieve the packet reception information collected from the set of all received frames [symbol] within the past T seconds, i.e., within the time interval [t̅ⱼ−T, t̅ⱼ], including one or more of: The packet reception times tₙ, Identifier of the transmitting tag: iₙ, Zone corresponding to the transmitting tag zₙ, The RSSI of the packet Rₙ (in dBm), Any zone metrics computed by the mobility module 730 \tilde{M}(z, tₙ).

for n∈ [symbol] . Here T can be a predetermined constant, e.g., T=30 seconds, or its value can be a function of the user device 330's current mobility state s and the state start time \tilde{t}, obtained from the packet reception module 720. For example, if the user device 330 state is stationary, the value of T can be from the time when the user device 330 has been stationary, and if the user device 330 is moving the value of T can be a small window of time such as 1 second. In addition, the zone detection module 710 may also query the packet reception module 720, to obtain the current state s and the state start time \tilde{t}. The metric for each zone may then be computed based on the information gathered from the mobility module 730 and the packet reception module 720.

The zone detection module 710 may apply corrections, weighting, and discount factors to the retrieved information at operation 810. For example, the zone detection module 710 may use some additional zone-specific information to compute the metric for each zone, such as zone specific weights: W(z) to account for the variability in the packet transmission rate and/or likelihood of user device 330 presence in each zone.

Due to the low packet transmission rate from the ambient-power tags 340, packets from some tags may be received with significantly long back within the window of T secs, while from some tags may have been received more recently within the window. To prioritize the information received more recently, which has higher likelihood to be accurate when the user device 330 is moving, a “discount” function g(t̅ⱼ−tₙ) may be applied to the information collected from each packet n∈ [symbol] . For example, the discount function may be any of the following:
(i) An exponential decay given by g(t)=exp {−t/T_{c}}, where T_{c} is a predetermined constant, e.g., T_{c}=10 seconds.
(ii) A delayed exponential decay given by

$$g ( t ) = min \{ exp \{ - \frac{t - {T}_{d}}{{T}_{c}} \} , 1 \} ,$$

where T_{d} is a grace time for which no decay is applied, e.g., T_{d}=2 seconds.
(iii) A linear decay function given by g(t)=−αt.
(iv) A window decay given by g(t)=1 for t≤T_{d} and g(t)=0 otherwise, where T_{d} is the duration of validity of a received measurement.

These discount functions may be applied to, for example, the RSSI values Rₙ or the zone identifier function I(z,zₙ), which returns a value of 1 for z=zₙ and 0 for z≠zₙ, during reception of packet n∈ [symbol] . In one variant of this embodiment, the constants T_{c}, T_{d} defined above may have different values depending on whether the user device 330 is stationary or is moving, as indicated by the packet reception module 720. In another variant of this embodiment, where the packet reception module 720 provides location information, the values of T_{c}, T_{d} may be larger for received data sample n∈ [symbol] , if the receiver location at time tₙ is within a close threshold distance D of user device 330 location at current time t̅ⱼ. For other samples n∈ [symbol] with farther location, a smaller value of T_{c}, T_{d} may be used.

Due to the polarization of the ambient-power tags 340 and the receive antenna of the user device 330, there may be an additional unknown variability in the received RSSI values Rₙ depending on the device and tag orientation. Correspondingly, among all the received RSSI values from the zone during the time window [t̅ⱼ−T, t̅ⱼ], when computing the zone metric, a higher emphasis may be given to larger RSSI values, which are likely to have the correct orientation of the tag with the receive antenna. The discount function g(t̅ⱼ−tₙ) may still be applied when comparing the RSSI values. This emphasis may be given to higher RSSI values can be given, for example, by taking the maximum discounted RSSI values from zone z within the time window:

$${max}_{n ∈ {𝒩}_{j} \vert {z}_{n} = z} \{ {R}_{n} g ( {\overline{t}}_{j} - {t}_{n} ) \} .$$

Additionally or alternatively the higher RSSI values can be given, for example, by taking the Lₚ norm of the discounted RSSI values from zone z within the time window: [symbol] |Rₙg(t̅ⱼ−tₙ)|^{p}, where p is a predetermined constant, e.g., p=4.

The zone detection module 710 may determine metrics for each zone based on the collected information at operation 812. In general, it may be considered that the ambient-power tags 340 belonging to the same zone as the user device 330 may produce a stronger RSSI and more frequent successful packet receptions, than packets of other zones. This is exploited in the zone-specific metrics provided. A few example pseudo-codes of such zone metric computation are described below.

### Example 1: Pseudocode for Max-RSSI Metric

```
Assume the computation is being done at time t̅ⱼ.
Fetch packet reception data for past T = 30 secs \\Time window for fetched packet reception data
Let the set of the indices of the fetched data be [symbol]   .
Let W(z) be a predetermined zone-specific weight function.
Set RSSIₘᵢₙ = − 110 dBm. \\Minimum expected received RSSI value
Set Mₜₑₘₚ(z) = 0 for all z ∈ [symbol]   .
For n ∈ [symbol]   \\Here [symbol]   is the number of received frames within the time window [t̅ⱼ − T, t̅ⱼ].
  If Rₙ ≥ RSSIₘᵢₙ
    Mₜₑₘₚ(zₙ) = max{Mₜₑₘₚ(zₙ), W(zₙ)g(t̅ⱼ − tₙ)(Rₙ − RSSIₘᵢₙ)}. \\Here g(. ) is a
  discount function.
  EndIf
EndFor
Return M[z, t̅ⱼ] = Mₜₑₘₚ(z) for each z ∈ [symbol]   .
```

### Example 2: Pseudocode for Lp Norm Metric

```
Assume the computation is being done at time t̅ⱼ.
Fetch packet reception data for past T = 30 secs \\Time window for fetched packet reception data
Let the set of the indices of the fetched data be [symbol]   .
Let W(z) be a predetermined zone-specific weight function.
Set RSSIₘᵢₙ = − 110 dBm. \\Minimum expected received RSSI value
Set Mₜₑₘₚ(z) = 0 for all z ∈ [symbol]   .
For n ∈ [symbol]   \\Here [symbol]   is the number of received frames within the time window [t̅ⱼ − T, t̅ⱼ].
  If Rₙ ≥ RSSIₘᵢₙ
    Mₜₑₘₚ(zₙ) = Mₜₑₘₚ(zₙ) + [W(zₙ)g(t̅ⱼ − tₙ)(Rₙ − RSSIₘᵢₙ )]^{p}. \\Here g(. ) is a
  discount function.
  EndIf
EndFor
Return M[z, t̅ⱼ] = Mₜₑₘₚ(z) for each z ∈ [symbol]   .
```

### Example 3: Pseudocode for Packet Count Metric

```
Assume the computation is being done at time t̅ⱼ.
Fetch packet reception data for past T = 30 secs \\Time window for fetched packet reception data
Let the set of the indices of the fetched data be [symbol]   .
Let W(z) be a predetermined zone-specific weight function.
Set RSSIₘᵢₙ = − 100 dBm. \\Minimum received RSSI value for being included in packet count
Set Mₜₑₘₚ(z) = 0 for all z ∈ [symbol]   .
For n ∈ [symbol]   \\Here [symbol]   is the number of received frames within the time window [t̅ⱼ − T, t̅ⱼ].
  If Rₙ ≥ RSSIₘᵢₙ
    Mₜₑₘₚ(zₙ) = Mₜₑₘₚ(zₙ) + W(zₙ)g(t̅ⱼ − tₙ). \\Here g(. ) is a discount function.
  EndIf
EndFor
Return M[z, t̅ⱼ] = Mₜₑₘₚ(z) for each z ∈ [symbol]   .
```

### Example 4: Pseudocode for Weighted Max-RSSI Metric

```
Assume the computation is being done at time t̅ⱼ.
Fetch packet reception data for past T = 30 secs \\Time window for fetched packet reception data
Let the set of the indices of the fetched data be [symbol]   .
Let W(z) be a predetermined zone-specific weight function.
Set RSSIₘᵢₙ = − 110 dBm. \\Minimum expected received RSSI value
Set Mₜₑₘₚ(z) = 0 for all z ∈ [symbol]   .
Set Cₜₑₘₚ(z) = 0 for all z ∈ [symbol]   .
For n ∈ [symbol]   \\Here [symbol]   is the number of received frames within the time window [t̅ⱼ − T, t̅ⱼ].
  If Rₙ ≥ RSSIₘᵢₙ
    Mₜₑₘₚ(zₙ) = max{Mₜₑₘₚ(zₙ), W(zₙ)g(t̅ⱼ − tₙ)(Rₙ − RSSIₘᵢₙ)}. \\Here g(. ) is a
  discount function.
    Cₜₑₘₚ(zₙ) = Cₜₑₘₚ(zₙ) + W(zₙ)g(t̅ⱼ − tₙ). \\Here g(. ) is a discount function.
  EndIf
EndFor
Cₛᵤₘ = [symbol]   Cₜₑₘₚ(z).
Return M[z, t̅ⱼ] = Mₜₑₘₚ(z) × Cₜₑₘₚ(z)/Cₛᵤₘ for each z ∈ [symbol]   .
```

### Example 5: Pseudocode for Max-Adjusted RSSI Metric

```
Assume the computation is being done at time t̅ⱼ.
Fetch packet reception data for past T = 10 secs \\Time window for
fetched packet reception data
Let the set of the indices of the fetched data be [symbol]  .
Let W(z) be a predetermined zone-specific weight function.
Set RSSIₘᵢₙ = −110 dBm. \\Minimum expected received RSSI value
Set α = 10^{(-85-RSSI}^{ₘᵢₙ}^{)/10}. \\Configurable correction factor
Set Mₜₑₘₚ(z) = 0 for all z ∈ [symbol]  .
Set Cₜₑₘₚ(z) = 0 for all z ∈ [symbol]  .
For n ∈ [symbol]  \\Here [symbol]  is the number of received frames within the time
window [t̅ⱼ − T, t̅ⱼ].
      If Rₙ ≥ RSSIₘᵢₙ
            Mₜₑₘₚ(zₙ) = Mₜₑₘₚ(zₙ) + 10^{R}^{ₙ}^{/10}.
            Cₜₑₘₚ(zₙ) = Cₜₑₘₚ(zₙ) + 1.
      EndIf
EndFor
${C}_{max} = {max}_{z ∈ 𝒵} \{ {C}_{temp} ( z ) \} .$
$\begin{matrix}Return M [ z , {\overline{t}}_{j} ] = W ( z ) max \{ \frac{{M}_{temp} ( z )}{{C}_{temp} ( z )} - α \frac{{C}_{max} - {C}_{temp} ( z )}{{C}_{max}} , 0 \} for each \\ z ∈ 𝒵 .\end{matrix}$
```

The goal in this algorithm is to correct the bias in the RSSI values observed, which comes because higher RSSI values have higher chance of successful packet reception.

Assume the computation is being done at time t̅ⱼ.
Fetch packet reception data for past T secs, where:
$\begin{matrix}Set T = \{ \begin{matrix}0.5 & if mobility state is moving \\ {\overline{t}}_{j} - \tilde{t} & if mobility state s is static since time \tilde{t}\end{matrix} \backslash \backslash Time window \\ for fetched metrics data\end{matrix}$
Let the set of the indices of the fetched data be [symbol] .
M[z, t̅ⱼ] = mean{\tilde{M}(z, tₙ)|n ∈ [symbol] }, or
M[z, t̅ⱼ] = median{\tilde{M}(z, tₙ)|n ∈ [symbol] }.
\\Here [symbol] is the number of received frames within the time window [t̅ⱼ −
T, t̅ⱼ].
\\Here \tilde{M}(. ) is the metric returned by the Packet reception module,
computed at each packet reception time.
Return M[z, t̅ⱼ] for each z ∈ [symbol] .

Alternatively, the packet transmission rate from each tag 340 or zone 310 may not be identical. This may be due to, for example, difference in their distance to the energy sources, differences in their energizing efficiency, differences in the number of tags available in each zone, or a combination thereof. The transmit power of the transmissions from each zone may also not be identical, due to process variability of the manufacturing, surrounding materials around the tag, or a combination thereof. In one embodiment, such zone-specific differences may be determined for the deployment, and all or some of the aforementioned parameters T, p, g(·) may be assigned zone specific values to compensate for the differences. Additionally, an appropriate choice of the zone weight W(z) may also be used to emphasize or de-emphasize one zone over the other.

The zone detection module 710 may generate a zone estimate by determining a zone estimation method and using the collected information and zone metric at operation 814. For example, at each zone prediction time instant t̅ⱼ, the zone prediction module can generate the zone estimation \hat{z}(t̅ⱼ) based on these computed metrics M(z, t̅ⱼ) for z∈ [symbol] . In one variant, to compute the zone estimate, zone detection module at each instant t̅ⱼ may also query the Mobility module to retrieve the current mobility state s and the time \tilde{t} since which the current mobility state is active. A few examples of such estimation are discussed below:

In one example, the zone prediction can be generated as the maximizer of the metrics:

$$\hat{z} ( {\overline{t}}_{j} ) = {arg max}_{z ∈ Z} \{ M ( z , {\overline{t}}_{j} ) \} .$$

In another example, to prevent frequent switching of the estimated zone metrics, a hysteresis may be added where

$$\hat{z} ( {\overline{t}}_{j} ) = {arg max}_{z ∈ Z} \{ M ( z , {\overline{t}}_{j} ) \}$$

only if

$${max}_{z ∈ Z} \{ M ( z , \overline{{t}_{j}} ) \} \geq α {max}_{z ∈ Z} 2 \{ M ( z , {\overline{t}}_{j} ) \} ,$$

where max 2 { } refers to the second largest value of the argument, and α>1 is a design parameter. If this condition is not satisfied, then the previous zone prediction may be maintained, i.e., \hat{z}(t̅ⱼ)=\hat{z}(t̅ⱼ₋₁).

In another example, to prevent frequent switching of the estimated zone metrics, a different type of hysteresis condition may be used, wherein after if the zone estimate has changed, i.e., \hat{z}(t̅ⱼ)≠\hat{z}(t̅ⱼ₋₁), then no further zone transitions are allowed in the following K time instants, for example, by setting \hat{z}(t̅_{j+K})=\hat{z}(t̅_{j+K-1})=\hat{z}(t̅ⱼ₊₁)=\hat{z}(t̅ⱼ).

In another example, if the user device 330 state s indicates the user device 330 is moving, then the maximizer of metric (from above) can be used

$$\hat{z} ( {\overline{t}}_{j} ) = {arg max}_{z ∈ Z} \{ M ( z , {\overline{t}}_{j} ) \}$$

while if the user device 330 is indicated as static then any of the hysteresis conditions (from above) may be used. The goal can be to enable faster switching of the zone when user device 330 is moving, while minimizing the false alarm when the user device 330 is not moving by adding hysteresis to provide noise tolerance.

In yet another example, the zone estimate can be generated as the mode of the past K “raw” zone estimates, i.e.: \hat{z}(t̅ⱼ)=mode[\tilde{z}(t̅ⱼ), \tilde{z}(t̅ⱼ₋₁), . . . , \tilde{z}(t̅_{j-K})], where the raw estimates are

$$\tilde{z} ( {\overline{t}}_{k} ) = {arg max}_{z ∈ Z} \{ M ( z , {\overline{t}}_{k} ) \}$$

for j−K≤k≤j. Here the value of K can be constant, or it can be varied based on the mobility state of the user device 330 s and the start time of the current state \tilde{t}.

In yet another example, the zone estimate can be generated as the mode of the raw zone estimates (computed by the packet reception module) from the T seconds, i.e., \hat{z}(t̅ⱼ)=mode[\tilde{z}(tₙ)|n∈ [symbol] ], where [symbol] ={n|t̅ⱼ−T≤tₙ≤t̅ⱼ} and

$$\tilde{z} ( {t}_{n} ) = {arg max}_{z ∈ Z} \{ \tilde{M} ( z , {t}_{n} ) \} .$$

Here the value of K can be constant, or it can be varied based on the mobility state of the user device 330 s and the start time of the current state \tilde{t}.

The zone detection module 710 will store the zone estimate and the prediction timestamp at operation 816. For example, to enable the output of zone prediction to be used by other processes, the prediction timestamp, prediction output, and the prediction confidence information may also be saved in a buffer.

Although FIG. 8 illustrates one example of a process flow diagram of a zone detection module, various changes may be made to FIG. 8. For example, various components of FIG. 8 could be combined, further subdivided, or omitted and additional components could be added according to particular needs.

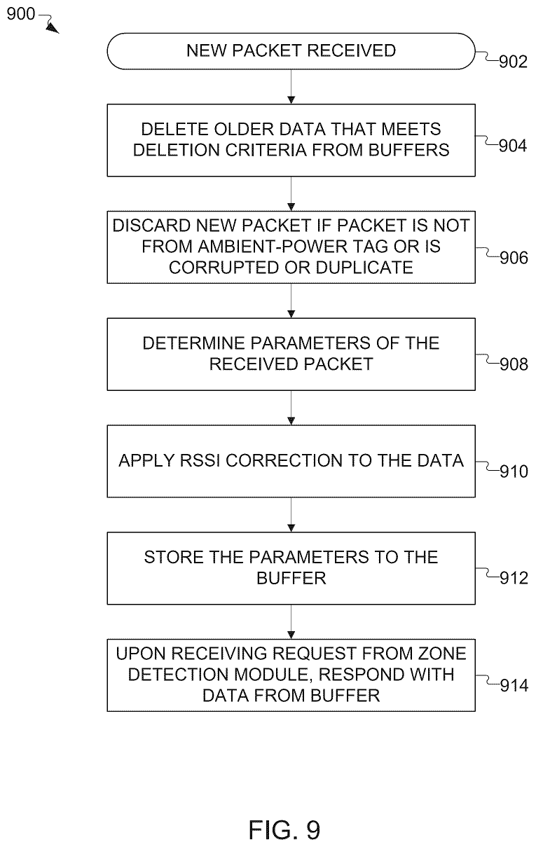

FIG. 9 illustrates an example process flow diagram 900 of a packet reception module of the zone estimation system 700 of FIG. 7 supporting indoor positioning using ambient-power tags according to embodiments of the present disclosure. The embodiment of the process flow diagram 900 shown in FIG. 9 is for illustration only. Other embodiments of the process flow diagram 900 could be used without departing from the scope of this disclosure.

As shown in FIG. 9, the packet reception module 720 receives a new packet at operation 902. For example, the mobility module 730 may be triggered every time a new packet n is received from one of the ambient-power tags 340, and it may log/buffer the collected parameters from the received packets.

The packet reception module 720 deletes older data that meets deletion criteria from buffers at operation 904. For example, the data may include parameters, such as packet reception times tₙ, identifier of the transmitting tag: iₙ, the zone corresponding to the transmitting tag zₙ, and the RSSI of the packet Rₙ. These parameters can be stored in a buffer which may periodically discard older parameters to limit the buffer size. In one example, the discarded parameters can be ones that are older than N̅ packets, i.e., upon receiving packet n, packets with indices below n−N̅ are discarded. In another example, the discarded packets may be the ones not received within the past T̅ seconds, i.e., with reception time less than tₙ−T̅, where T̅ is a configurable parameter, e.g., 30 seconds. In one variant of this embodiment, module may also store the bias corrected RSSI values R̅ₙ for each packet n, which removes a bias in the observed RSSI values by exploiting the packet arrival rate (over a past time window) from that tag iₙ or zone zₙ. Here the bias in the RSSI values may come because higher RSSI values have higher chance of successful packet reception. In a variant, it may be these bias corrected RSSI values R̅ₙ that are sent to the zone detection module 710 (instead of raw RSSI Rₙ) for use in the metric computation. The packet reception module 720 discards the new packet if the packet is not from an ambient-power tags 340 or is corrupted, erroneous, or a duplicate at operation 906.

The packet reception module 720 determines the parameters of the received packet at operation 908. For example, some zone metrics \tilde{M}(z, tₙ), may be computed and logged by the mobility module 730 at each packet reception time tₙ. These metrics may be retrieved by the zone detection module 710 to compute the final zone metric and/or the final zone estimate. A similar discount function g(t) may be applied to the older information here, as discussed in FIG. 8. The parameters for the metric computation can be pre-fixed or can be queried and retrieved from the zone detection module 710. A few example pseudo-codes of such zone metric computation are described below.

### Example 1: Pseudocode for Max-RSSI Metric

```
Assume the computation is being done at reception time of packet n.
Set RSSIₘᵢₙ = − 110 dBm. \\Minimum expected received RSSI value
For z ∈ [symbol]
  If z == zₙ and Rₙ ≥ RSSIₘᵢₙ
    \tilde{M}(z, tₙ) = max{g(tₙ − tₙ₋₁)\tilde{M}(z, tₙ₋₁), (Rₙ − RSSIₘᵢₙ)}. \\Here g(. ) is a discount
  function.
  Else
    \tilde{M}(z, tₙ) = g(tₙ − tₙ₋₁)\tilde{M}(z, tₙ₋₁)
  EndIf
EndFor
Return \tilde{M}(z, tₙ) for each z ∈ [symbol]   .
```

### Example 2: Pseudocode for Lp Norm Metric

```
Assume the computation is being done at reception time of packet n.
Set RSSIₘᵢₙ = − 110 dBm. \\Minimum expected received RSSI value
For z ∈ [symbol]
  If z == zₙ and Rₙ ≥ RSSIₘᵢₙ
    \tilde{M}(z, tₙ) = g(tₙ − tₙ₋₁)^{p}\tilde{M}(z, tₙ₋₁) + (Rₙ − RSSIₘᵢₙ)^{p}. \\Here g(. ) is a discount
  function.
  Else
    \tilde{M}(z, tₙ) = g(tₙ − tₙ₋₁)^{p}\tilde{M}(z, tₙ₋₁)
  EndIf
EndFor
Return \tilde{M}(z, tₙ) for each z ∈ [symbol]   .
```

### Example 3: Pseudocode for Packet Count Metric

```
Assume the computation is being done at reception time of packet n.
Set RSSIₘᵢₙ = − 100 dBm. \\Minimum received RSSI value for being included in packet count
For z ∈ [symbol]
  If z == zₙ and Rₙ ≥ RSSIₘᵢₙ
    \tilde{M}(z, tₙ) = g(tₙ − tₙ₋₁)\tilde{M}(z, tₙ₋₁) + 1. \\Here g(. ) is a discount function.
  Else
    \tilde{M}(z, tₙ) = g(tₙ − tₙ₋₁)\tilde{M}(z, tₙ₋₁)
  EndIf
EndFor
Return \tilde{M}(z, tₙ) for each z ∈ [symbol]   .
```

### Example 4: Pseudocode for Weighted Max-RSSI Metric

```
Assume the computation is being done at reception time of packet n.
Set RSSIₘᵢₙ = − 110 dBm. \\Minimum expected received RSSI value
If n == 1
  Mₜₑₘₚ(z) = 0, Cₜₑₘₚ(z) = 0 for all z ∈ [symbol]
EndIf
For z ∈ [symbol]
  If z == zₙ and Rₙ ≥ RSSIₘᵢₙ
    Mₜₑₘₚ(z) = max{g(tₙ − tₙ₋₁)Mₜₑₘₚ(z), (Rₙ − RSSIₘᵢₙ)}. \\Here g(. ) is a discount
  function.
    Cₜₑₘₚ(z) = Cₜₑₘₚ(z, n − 1) + 1.
  Else
    Mₜₑₘₚ(z) = g(tₙ − tₙ₋₁)Mₜₑₘₚ(z)
    Cₜₑₘₚ(z) = g(tₙ − tₙ₋₁)Cₜₑₘₚ(z).
  EndIf
EndFor
Cₛᵤₘ = [symbol]   Cₜₑₘₚ(z).
Return \tilde{M}(z, tₙ) = Mₜₑₘₚ(z) × Cₜₑₘₚ(z)/Cₛᵤₘ for each z ∈ [symbol]   .
```

The packet reception module 720 applies RSSI correction to the data from the packet at operation 910. For example, the packet reception module 720 may calculate an RSSI correction based on a minimum expected RSSI value. An example of pseudo-code of such a computation are described below.

### Example 5: Pseudocode for Max-Adjusted RSSI Metric

```
Assume the computation is being done at reception time of packet n.
Set RSSIₘᵢₙ = −110 dBm. \\Minimum expected received RSSI value
Set α = 10^{(-85-RSSI}^{ₘᵢₙ}^{)/10}. \\Configurable correction factor
If n = = 1
      Mₜₑₘₚ(z) = 0, Cₜₑₘₚ(z) = 0 for all z ∈ [symbol]
EndIf
\\Compute the current average packet rate
For z ∈ [symbol]
      If z = = zₙ and Rₙ ≥ RSSIₘᵢₙ
            Cₜₑₘₚ(z) = Cₜₑₘₚ(z, n − 1) + 1.
      Else
            Cₜₑₘₚ(z) = g(tₙ − tₙ₋₁)Cₜₑₘₚ(z). \\Here g(. ) is a discount
            function.
      EndIf
EndFor
${C}_{max} = {max}_{z ∈ 𝒵} \{ {C}_{temp} ( z ) \} .$
\\Compute the RSSI correction factor
For z ∈ [symbol]
      If z = = zₙ and Rₙ ≥ RSSIₘᵢₙ
            $\begin{matrix}{M}_{temp} ( z ) = max \{ g ( {t}_{n} - {t}_{n - 1} ) {M}_{temp} ( z ) , {10}^{( {R}_{n} - {RSSI}_{min} ) / 10} - \\ α \frac{{C}_{max} - {C}_{temp} ( z )}{{C}_{max}} , 0 \} .\end{matrix}$
      Else
            Mₜₑₘₚ(z) = g(tₙ − tₙ₋₁)Mₜₑₘₚ(z). \\Here g(. ) is a discount
            function.
      EndIf
EndFor
Return \tilde{M}(z, tₙ) = 10 log₁₀(Mₜₑₘₚ(z)) for each z ∈ [symbol]  .
```

The packet reception module 720 stores the parameters in the buffer at operation 912. The packet reception module 720, upon receiving a request from the zone detection module 710, responds with the data from the buffer at operation 914. For example, upon receiving a query from the zone detection module 710 at a time t̅ⱼ along with a time window indication T, the mobility module 730 may determine a set of received frames [symbol] , and send one or more of the the stored parameters corresponding to the set [symbol] to the zone detection module 710. Here [symbol] can be, for example, all packets n such that t̅ⱼ−T≤tₙ≤t̅ⱼ.

Although FIG. 9 illustrates one example of a process flow diagram of a packet reception module, various changes may be made to FIG. 9. For example, various components of FIG. 9 could be combined, further subdivided, or omitted and additional components could be added according to particular needs.

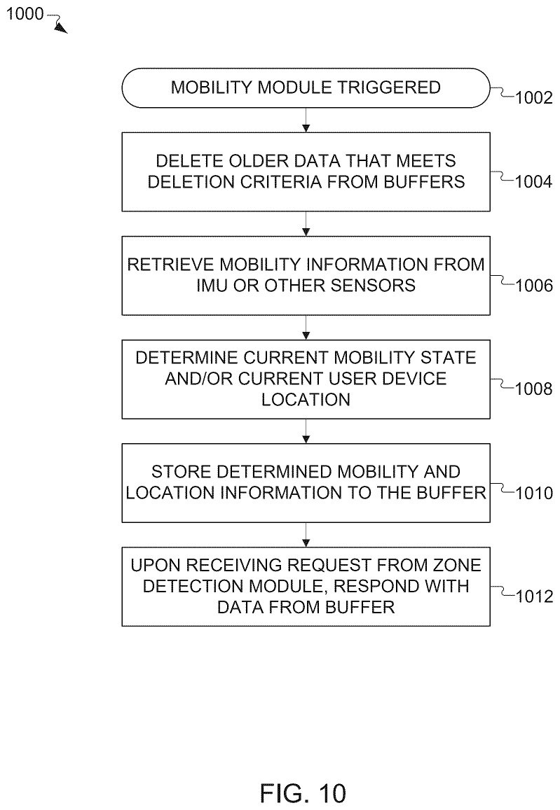

FIG. 10 illustrates an example process flow diagram 1000 of a mobility module of the zone estimation system 700 of FIG. 7 supporting indoor positioning using ambient-power tags according to embodiments of the present disclosure. The embodiment of the process flow diagram 1000 shown in FIG. 10 is for illustration only. Other embodiments of the process flow diagram 1000 could be used without departing from the scope of this disclosure.

As shown in FIG. 10, the mobility module 730 may be triggered at operation 1002. For example, the mobility module 730 may be triggered every time the inertial motion unit (IMU) sensor generates a new acceleration and/or gyroscope data, or it can be generated at periodic intervals, e.g., of 0.1 s.

The mobility module 730 may delete older data that meets a deletion criteria from its buffers at operation 1004. For example, the data may include parameters that are stored in a buffer which may periodically discard older parameters to limit the buffer size. In one example, the discarded parameters can be ones that are older than N̅ packets, i.e., upon receiving packet n, packets with indices below n−N̅ are discarded. In another example, the discarded packets may be the ones not received within the past T̅ seconds, i.e., with reception time less than tₙ−T̅, where T̅ is a configurable parameter, e.g., 30 seconds.

The mobility module 730 may retrieve mobility information from an IMU or other sensors at operation 1006. For example, to generate the mobility prediction, the mobility module 730 may use linear acceleration information from the IMU sensor from one or more axis, gyroscope-based rotation information from the IMU sensor for one or more axis, magnetometer-based heading information from the IMU sensor for one or more axis, step count information from a step counter app on phone or other allied device, e.g., smart watch, or a combination thereof. The relative motion trajectory of the user device 330 (i.e., step time, step length, and step direction information) generated from a pedestrian dead reckoning (PDR) algorithm. The aforementioned information received within the past T seconds may also be stored by the mobility module 730 in a buffer.

The mobility module 730 may then determine a current mobility state and/or current user device 330 location at operation 1008. For example, at each triggered time, based on the stored information, in one embodiment, the mobility module 730 may generate a prediction of whether, for example, the user device 330 is fully static, moving but user device 330 location is static, moving slowly, moving quickly, or a combination thereof.

The predicted state s and the time t since when the current predicted state is active may be logged and stored in a buffer. In a variant, the prediction may be limited to a subset of the above identified classes.

Additionally, or alternatively, the mobility module 730 may predict the current location of the user device 330 (x,y,z) and store the user device 330 location along with the current time stamp t. These predicted locations can be generated, for example using a PDR algorithm and may have both a slow varying translation error and a slow varying rotation error. These values (x, y, z, t) may be stored by the module in a repository. In a variant of this embodiment, instead of directly storing the locations, the module may store the step time, step direction and step length information (which captures similar information).

The mobility module 730 may store the determined mobility and location information in its buffers at operation 1010. The packet reception module 720, upon receiving a request from the zone detection module 710, responds with the data from the buffer at operation 1012. For example, upon receiving a query from the zone detection module 710 at a time t̅ⱼ, the mobility module 730 may respond with the current state s and the time since when the state is active \tilde{t}. In a variant of this embodiment, upon receiving a query from the zone detection module 710 at a time t̅ⱼ along with a time window indication T, the mobility module 730 may return multiple pairs of state and state start times (s, \tilde{t}), which satisfy t̅ⱼ−T≤\tilde{t}≤t̅ⱼ. In another variant of this embodiment, where the mobility module 730 also keeps track of the user device 330 location, the module may respond with the location information (x, y, z, t) for t̅ⱼ−T≤t≤t̅ⱼ.

Although FIG. 10 illustrates one example of a process flow diagram of a mobility module of the zone estimation system of FIG. 7 supporting indoor positioning using ambient-power tags, various changes may be made to FIG. 10. For example, various components of FIG. 10 could be combined, further subdivided, or omitted and additional components could be added according to particular needs.

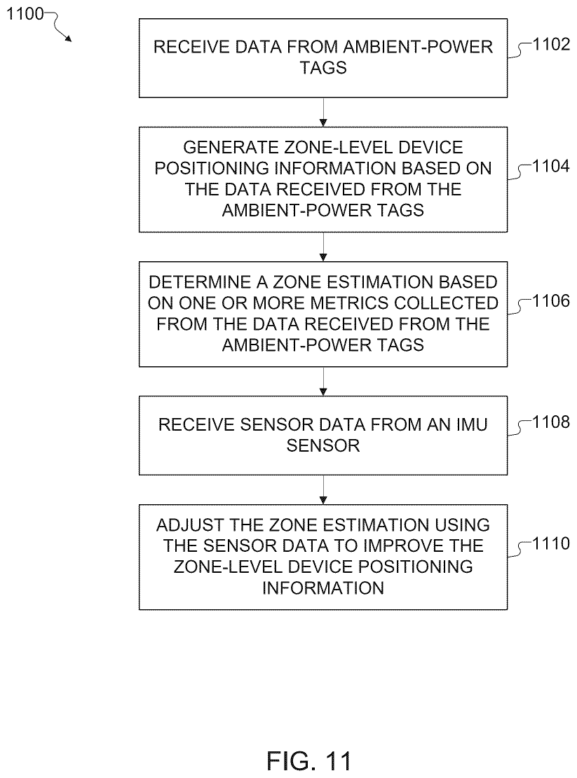

FIG. 11 illustrates an example method 1100 for indoor positioning using ambient-power tags according to embodiments of the present disclosure. An embodiment of the method illustrated in FIG. 11 is for illustration only. One or more of the components illustrated in FIG. 11 may be implemented in specialized circuitry configured to perform the noted functions or one or more of the components may be implemented by one or more processors executing instructions to perform the noted functions. Other embodiments of indoor positioning using ambient-power tags could be used without departing from the scope of this disclosure.

As shown in FIG. 11, data is received from the ambient-power tags, wherein the ambient-power tags are configured to function as anchor nodes at step 1102. For example, the packet reception module 720 may receive data from one or more of the ambient-power tags 340.

Zone-level device positioning information is generated based on the data received from the ambient-power tags at step 1104. Generating the zone-level device positioning information based on the data received from the ambient-power tags may include receiving data for position identification from ambient-power tags deployed in a cluster of tags having different orientations with respect to a user device 330. For example, the zone detection module 710 may receive packet reception data 722 from the packet reception module 720.

A zone estimation is determined based on one or more metrics collected from the data received from the ambient-power tags at step 1106. For example, determining the zone estimation based on the one or more metrics collected from the data received from the ambient-power tags may include scanning for received packets from the ambient-power tags, storing data from the received packets, periodically determining a zone metric for each zone of a zone map using the stored data, and generating a zone estimation based on the zone metric. The zone metric may be based on an RSRP of the received packets, a time elapsed since a previous reception of each of the received packets, or a combination thereof. Determining the zone metric may include applying zone-specific weights to the initial zone metric to generate a weighted zone metric. Additionally or alternatively, Determining the zone metric may include retrieving packet reception data 822 from the stored data collected from all received frames within a predetermined window (such as in a buffer of the packet reception module 820) to generate an initial zone metric.

Sensor data is received from an inertial measurement unit (IMU)-sensor at step 1108. For example, the zone detection module 710 may receive mobility data 732 from the mobility module 730, including IMU data and other sensor data.

The zone estimation is adjusted using the sensor data to improve the zone-level device positioning information at step 1110. For example, adjusting the zone estimation using the sensor data to improve the zone-level device positioning information includes using the sensor data to determine a current mobility state of a user device 330 and adjusting the zone estimation based on the current mobility state.

Although FIG. 11 illustrates one example method for indoor positioning using ambient-power tags, various changes may be made to FIG. 11. For example, while shown as a series of steps, various steps in FIG. 11 may overlap, occur in parallel, occur in a different order, or occur any number of times.

The above flowcharts illustrate example methods that can be implemented in accordance with the principles of the present disclosure and various changes could be made to the methods illustrated in the flowcharts herein. For example, while shown as a series of steps, various steps in each figure could overlap, occur in parallel, occur in a different order, or occur multiple times. In another example, steps may be omitted or replaced by other steps.

Although the present disclosure has been described with exemplary embodiments, various changes and modifications may be suggested to one skilled in the art. It is intended that the present disclosure encompass such changes and modifications as fall within the scope of the appended claims. None of the description in this application should be read as implying that any particular element, step, or function is an essential element that must be included in the claims scope. The scope of patented subject matter is defined by the claims.

What is claimed is:

1. A method comprising:
receiving data from ambient-power tags, wherein the ambient-power tags are configured to function as anchor nodes;
generating zone-level device positioning information based on the data received from the ambient-power tags;
determining a zone estimation based on one or more metrics collected from the data received from the ambient-power tags;
receiving sensor data from an inertial measurement unit (IMU)-sensor; and
adjusting the zone estimation using the sensor data to improve the zone-level device positioning information.

2. The method of claim 1, wherein the ambient-power tags are deployed in zones by:
disposing the ambient-power tags in an upper portion of a zone;
disposing the ambient-power tags as a cluster of tags having different orientations with respect to a user device within a zone; or
both.

3. The method of claim 1, wherein generating the zone-level device positioning information based on the data received from the ambient-power tags comprises receiving data for position identification from ambient-power tags deployed in a cluster of tags having different orientations with respect to a user device.

4. The method of claim 1, wherein determining the zone estimation based on the one or more metrics collected from the data received from the ambient-power tags comprises:
scanning for received packets from the ambient-power tags;
storing data from the received packets;
periodically determining a zone metric for each zone of a zone map using the stored data; and
generating a zone estimation based on the zone metric.

5. The method of claim 4, wherein the zone metric is based on an RSRP of the received packets, a time elapsed since a previous reception of each of the received packets, or a combination thereof.

6. The method of claim 4, wherein determining the zone metric comprises retrieving packet reception data from the stored data collected from all received frames within a predetermined window to generate an initial zone metric.

7. The method of claim 6, wherein determining the zone metric comprises applying zone-specific weights to the initial zone metric to generate a weighted zone metric.

8. The method of claim 1, wherein adjusting the zone estimation using the sensor data to improve the zone-level device positioning information comprises using the sensor data to determine a current mobility state of a user device and adjusting the zone estimation based on the current mobility state.

9. The method of claim 1, wherein the ambient-power tags are configured to transmit Wi-Fi packets or cellular standard-compliant packets.

10. An electronic device, comprising:
a processor operably coupled to ambient-power tags, configured to cause the electronic device to:
receive data from the ambient-power tags, wherein the ambient-power tags are configured to function as anchor nodes;
generate zone-level device positioning information based on the data received from the ambient-power tags;
determine a zone estimation based on one or more metrics collected from the data received from the ambient-power tags;
receive sensor data from an inertial measurement unit (IMU)-sensor; and
adjust the zone estimation using the sensor data to improve the zone-level device positioning information.

11. The electronic device of claim 10, wherein the ambient-power tags are deployed in zones by:
disposing the ambient-power tags in an upper portion of a zone;
disposing the ambient-power tags as a cluster of tags having different orientations with respect to a user device within a zone; or
both.

12. The electronic device of claim 10, wherein the processor, when causing the electronic device to generate the zone-level device positioning information based on the data received from the ambient-power tags, is further configured to cause the electronic device to:
receive data for position identification from ambient-power tags deployed in a cluster of tags having different orientations with respect to a user device.

13. The electronic device of claim 10, wherein the processor, when causing the electronic device to determine the zone estimation based on the one or more metrics collected from the data received from the ambient-power tags, is further configured to cause the electronic device to:
scan for received packets from the ambient-power tags;
store data from the received packets;
periodically determine a zone metric for each zone of a zone map using the stored data; and
generate a zone estimation based on the zone metric.

14. The electronic device of claim 13, wherein the zone metric is based on an RSRP of the received packets, a time elapsed since a previous reception of each of the received packets, or a combination thereof.

15. The electronic device of claim 13, wherein the processor, when causing the electronic device to determine the zone metric, is further configured to cause the electronic device to:
retrieve packet reception data from the stored data collected from all received frames within a predetermined window to generate an initial zone metric; and
apply zone-specific weights to the initial zone metric to generate a weighted zone metric.

16. A non-transitory computer-readable medium comprising program code, that when executed by at least one processor of an electronic device, causes the electronic device to:
receive data from ambient-power tags, wherein the ambient-power tags are configured to function as anchor nodes;
generate zone-level device positioning information based on the data received from the ambient-power tags;
determine a zone estimation based on one or more metrics collected from the data received from the ambient-power tags;
receive sensor data from an inertial measurement unit (IMU)-sensor; and
adjust the zone estimation using the sensor data to improve the zone-level device positioning information.

17. The non-transitory computer-readable medium of claim 16, wherein the program code, that when executed by the at least one processor, causes the electronic device to generate the zone-level device positioning information based on the data received from the ambient-power tags, further comprises program code, that when executed by the at least one processor, causes the electronic device to:
receive data for position identification from ambient-power tags deployed in a cluster of tags having different orientations with respect to a user device.

18. The non-transitory computer-readable medium of claim 16, wherein the program code, that when executed by the at least one processor, causes the electronic device to determine the zone estimation based on the one or more metrics collected from the data received from the ambient-power tags, further comprises program code, that when executed by the at least one processor, causes the electronic device to:
scan for received packets from the ambient-power tags;
store data from the received packets;
periodically determine a zone metric for each zone of a zone map using the stored data; and
generate a zone estimation based on the zone metric.

19. The non-transitory computer-readable medium of claim 18, wherein the program code, that when executed by the at least one processor, causes the electronic device to determine the zone metric, further comprises program code, that when executed by the at least one processor, causes the electronic device to:
retrieve packet reception data from the stored data collected from all received frames within a predetermined window to generate an initial zone metric; and
apply zone-specific weights to the initial zone metric to generate a weighted zone metric.

20. The non-transitory computer-readable medium of claim 16, wherein the program code, that when executed by the at least one processor, causes the electronic device to adjust the zone estimation using the sensor data to improve the zone-level device positioning information, further comprises program code, that when executed by the at least one processor, causes the electronic device to:
use the sensor data to determine a current mobility state of a user device and adjust the zone estimation based on the current mobility state.
